(19) United States
(12) Patent Application Publication
(10) Pub. No.: US 2007/0043965 A1
(43) Pub. Date: Feb. 22, 2007

(54) Dynamic memory sizing for power reduction

(75) Inventors: Julius Mandelblat, Haifa (IL); Moty Mehalel, Haifa (IL); Avi Mendelson, Haifa (IL); Alon Naveh, Ramet Hasharon (IL)

Correspondence Address: INTEL CORPORATION;C/O INTELLEVATE, LLC, P.O. BOX 52050, MINNEAPOLIS, MN, 55402, US

(73) Assignee: INTEL CORPORATION

(21) Appl. No.: 11/208,935

(22) Filed: Aug. 22, 2005

(51) Int. Cl. G06F 1/26

(52) U.S. Cl. 713/324

(57) ABSTRACT

Systems and methods of dynamic memory for power reduction are described with respect to a memory with a coupled sleep device. In one embodiment, the operating requirements can reflect amount of memory required to perform commensurate operations. Memory power management logic is used to coordinate memory requirements with operating requirements. The sleep device is able to enable or disable the memory based on the requirements to reduce power consumption.

### BACKGROUND

1. Technical Field

One or more embodiments of the present invention generally relate to integrated circuits and/or computing systems. In particular, certain embodiments relate to power management of memory circuits.

2. Discussion

As the trend toward advanced processors with more transistors and higher frequencies continues to grow, computer designers and manufacturers are often faced with corresponding increases in power consumption. Furthermore, manufacturing technologies that provide faster and smaller components can at the same time result in increased leakage power. Particularly in mobile computing environments, these increases can lead to overheating, which may negatively affect performance, and can significantly reduce battery life.

With the focus on performance and small form factors, in a microprocessor, for example, cache memory sizes are increasing to achieve the best performance for a given silicon area. These recent trends toward even larger memory sizes have increased the portion of power consumption associated with memories. As a result, the leakage power that is dissipated by the memory is quite significant relative to the total power of the central processing unit (CPU).

### BRIEF DESCRIPTION OF THE DRAWINGS

Various advantages of embodiments of the present invention will become apparent to one skilled in the art by reading the following specification and appended claims, and by referencing the following drawings, in which:

FIG. 1 is a block diagram of an example of a memory architecture to implement dynamic sizing according to one embodiment of the invention;

FIG. 2 is a diagram of another example of a memory architecture to implement dynamic sizing according to one embodiment of the invention;

FIG. 3 is a diagram of a cell-level example of a memory architecture to implement dynamic sizing according to one embodiment of the invention;

FIG. 4 is a diagram of a cell-level example of a memory architecture to implement dynamic sizing according to one embodiment of the invention;

FIG. 5 is a diagram of another cell-level example of a memory architecture to implement dynamic sizing according to one embodiment of the invention;

FIGS. 6-8 are diagrams of various examples of sleep devices according to embodiments of the invention;

FIG. 9 is a system-level block diagram of an example computer system according to embodiments of the invention;

FIG. 10 is a flowchart of an example of a method of managing dynamic memory sizing according to one embodiment of the invention;

FIG. 11 is a flowchart of another example of a method of managing dynamic memory sizing according to one embodiment of the invention; and

FIG. 12 is a state diagram of an example of a dynamic memory management machine according to one embodiment of the invention.

### DETAILED DESCRIPTION

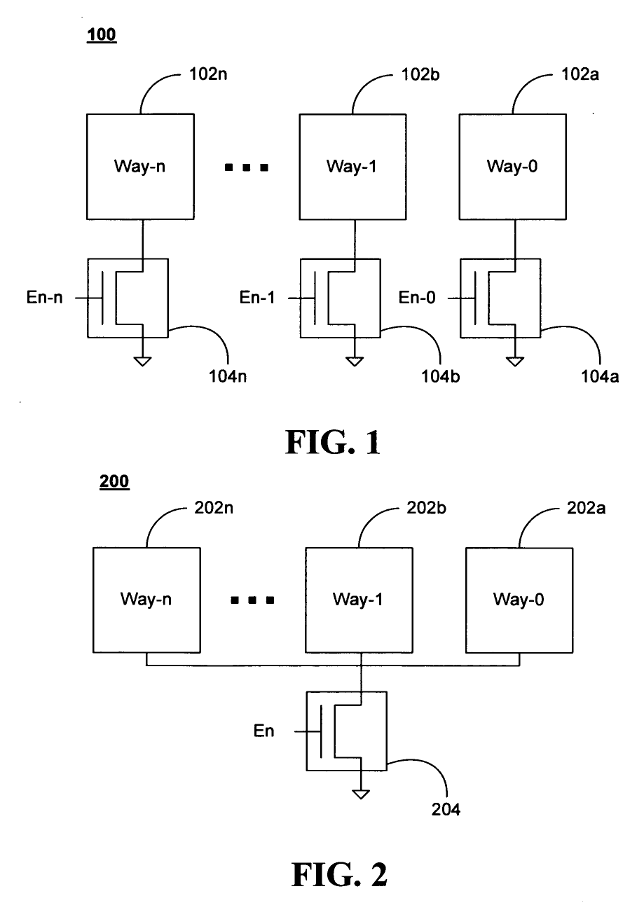

The amount of memory that may actually be required by a computer system and/or associated software often varies with respect to time. For typical applications, for example, only a small portion of the memory may be needed at any given time. According to one or more embodiments, a memory, such as the memory of FIG. 1, may be dynamically sized to reduce the power requirements of a memory circuit and the system in which it is used. Specifically, as is described herein, embodiments of the invention may provide a reduction in power consumption without substantially affecting performance by disabling one or more sub-sections of a memory when those sub-sections are not needed and/or are unselected.

FIG. 1 shows a representation of a dynamically sizable memory 100 according to one embodiment. The dynamically sizable memory of the example embodiment of FIG. 1 is an n-way associative cache memory that may be implemented, for example, using static random access memory (SRAM). The dynamically sizable memory 100 includes a plurality of sub-sections 102a, 102b-102n (each of which are ways in this particular example), each separately coupled to a plurality of sleep devices 104a, 104b-104n, respectively, as shown, such that each of the sub-sections or ways 102 may be selectively enabled/disabled. The sleep devices 104, according to one or more embodiments of the invention, may include a sleep transistor that is used to selectively couple/decouple an associated sub-section of a memory to a power source.

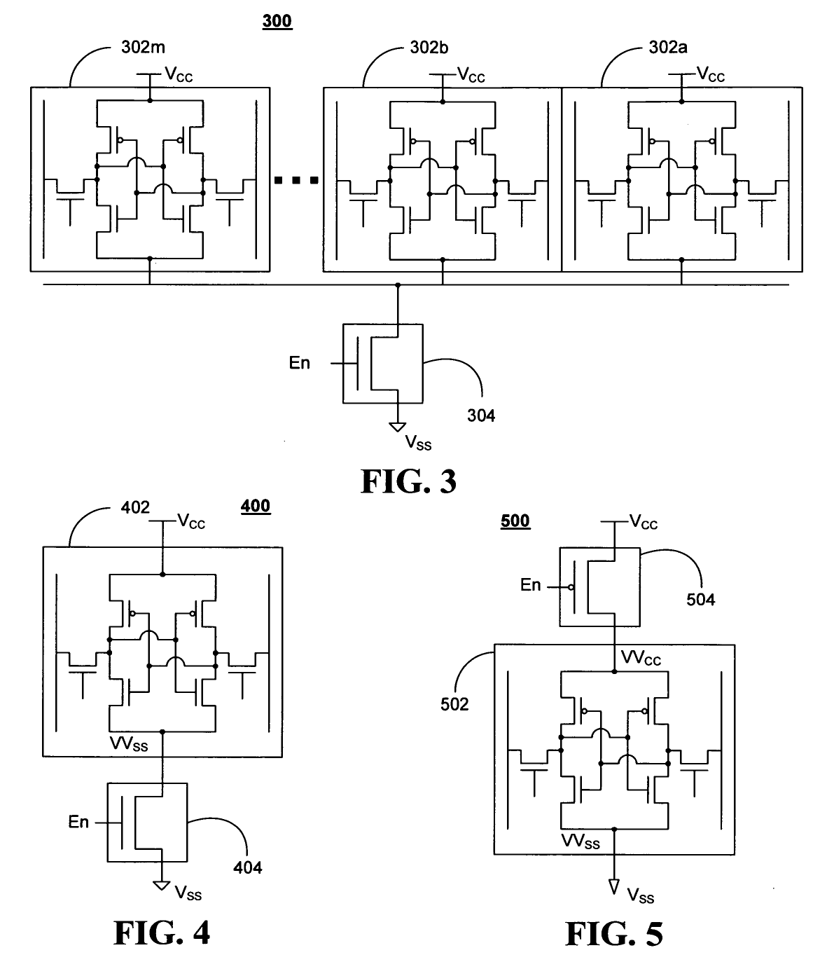

FIG. 3 illustrates an example sub-section or way 300 of such an implementation at the transistor level. The way 300 includes cells 302a, 302b-302m coupled to a sleep device 304. The power supply of the way 300 may be coupled to global power lines of the host integrated circuit through a serial transistor 304, which may be referred to herein as a sleep device or sleep transistor. FIG. 4 shows a single cell 402 that may correspond to one of the cells 302 of FIG. 3. More specifically, as shown in FIGS. 3 and 4, the input port of the sleep devices 304 and 404 is coupled to the power supply (Vss in this example) and the output port is coupled to the array supply, which may be referred to as the virtual power supply of the array or VVss.

While the example embodiments of FIGS. 3 and 4 show a sleep device coupled between a sub-section of the memory and Vss, for alternative embodiments, the sleep device may be instead be coupled between the sub-section of the memory and Vcc as shown for the cell 502 in FIG. 5, or a sleep circuit may be coupled between each of Vcc and Vss and the associated sub-section.

In accordance with one or more embodiments, the sleep device may be on as long as the associated way is active and may be turned off if it is determined that the associated way is to be deactivated. As a result of turning off a sleep device and disabling an associated sub-section of memory, the rail-to-rail voltage of the virtual power supply is reduced. The leakage power of the associated memory array may therefore be reduced since the leakage is dependent on the voltage (See Equation 1 below).
Ilkg=k·Vⁿ (Eq. 1)

Where I_{lkg} is Leakage current; V is Rail-to-rail voltage; k may be a constant; and n may be, but is not required to be, greater than 3.

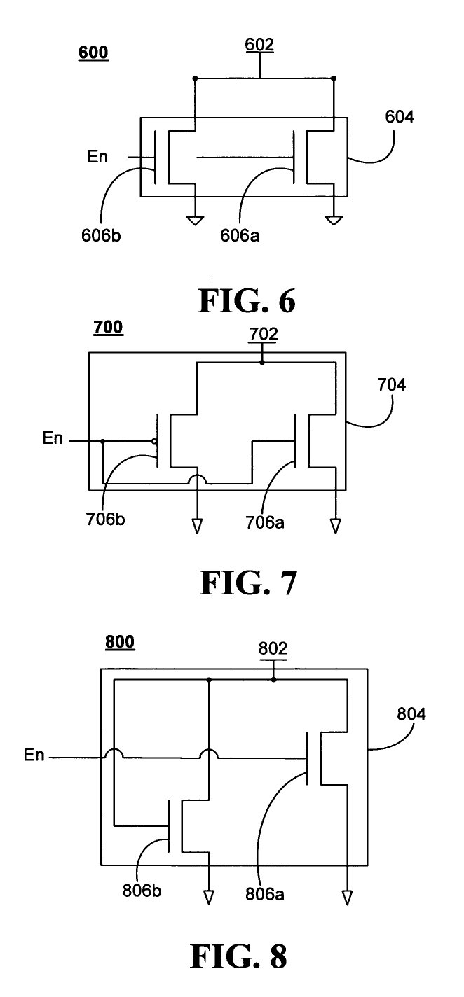

FIGS. 6-7 show alternative embodiments of the sleep device, according to embodiments of the invention. FIG. 6 shows a sleep device 604 with two sleep transistors, 606a and 606b. The advantages of this configuration include, but are not limited to, cases where sleep transistor 606a has a different resistance value than 606b. In embodiments, by reducing the size of the sleep transistor 606a, the voltage at the gate of the sleep transistor 606a may be higher than GROUND and therefore doesn't require as much voltage to disable a way or cell 602.

Similarly, other advantages are provided by the sleep device 704 shown in FIG. 7, and sleep device 804 shown in FIG. 8. The sleep device 704 may provide for a gradual reduction in the power provided to a way or cell 702. The sleep device 804 may provide for a limited reduction in power provided to a way or cell 802. The alternative sleep devices of FIGS. 6-8 provide alternative embodiments which are illustrative of the types of sleep devices which may be employed by one of ordinary skill in the art, based at least on the teachings provided herein, according to embodiments of the invention and are not intended to limit the scope of the invention. Moreover, as may be apparent to one of ordinary skill, these various embodiments of sleep devices may have applications which are more specialized than others and may be more advantageous, therefore, for certain dynamically sizable memory.

For other embodiments, various circuit and/or other techniques may be used to implement alternative sleep logic and/or to provide functionality similar to the sleep devices using a different approach. In one embodiment of the invention, for example, different sub-sections of a memory may be implemented on different power planes such that sub-sections of the memory may be enabled/disabled through power plane control. Other approaches are within the scope of various embodiments.

While a plurality of individual pairs of ways and associated sleep devices are shown here, embodiments of the invention may readily be implemented in various arrangements without departing from the spirit and scope of the embodiments of the invention. FIG. 2, for example, shows a dynamic memory 200 according to an alternative embodiment of the invention that includes a plurality of ways 202a, 202b-202n, where n may be a number greater than one, coupled to a single sleep device 204. The ways and sleep devices may be similar in function and design to those described in FIG. 1 except, in this embodiment, the sleep device 204 may be deactivated to disable all of the ways associated with it.

Further, while an n-way associative cache memory implemented on a microprocessor is described herein for purposes of illustration, it will be appreciated that embodiments of the invention may be applied to other types of memory, including cache memories having a different architecture and/or memories implemented on another type of integrated circuit device.

For other embodiments, for example, other partitions, sub-sections or portions of memory, including cache memories of various levels, may be selectively enabled and/or disabled using one or more of the approaches described herein. The illustrated ways may therefore provide a convenient grouping of cells, such as an array, but use of the term ‘ways’ is not intended to limit the spirit or scope of the invention.

Referring back to FIG. 1, as described above, sleep device 104a may be deactivated to disable way 102a when way 102a is not needed, thus providing a leakage power savings or activated to enable way 102a. It is noted that the use of the term enable with respect to the memory refers to the powering, at any active level, of the memory; while the use of the term disable refers to the removal or blocking of power to the memory. From a logical standpoint, according to embodiments of the invention described herein, enabled memory may be accessed for READ/WRITE operations, while disabled memory may not.

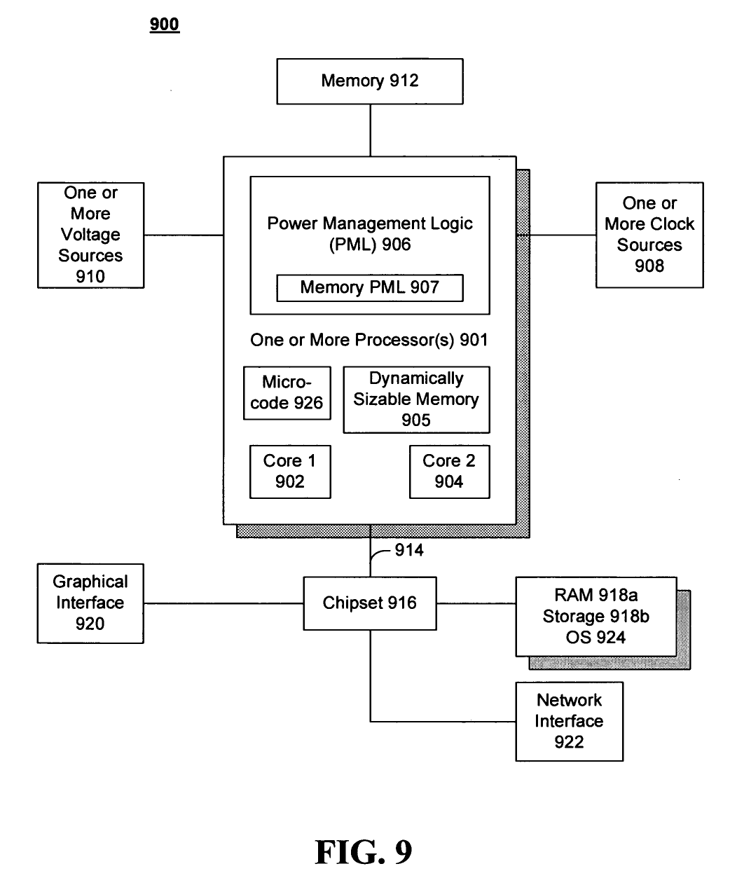

According to one or more embodiments, to enable and/or disable associated sub-sections of the dynamically sizable memory 100, the sleep devices 104a-104n may be controlled by memory power management logic or other logic (not shown), which may be implemented in a host integrated circuit, a computer system or in software. An example of such an implementation is described below in reference to FIG. 9.

FIG. 9 is a block diagram of a computer system 900 having a dynamically sizable memory 905 according to an example embodiment of the invention. The computer system 900 may be a personal computer system such as, for example, a laptop, notebook or desktop computer system. The computer system 900 may include one or more processors 901, which may include sub-blocks such as, but not limited to, one or more cores, illustrated by core 902 and core 904, the dynamically sizable cache memory 905, which may, for example, be an L2 cache memory, and power management logic 906, which may include memory power management logic 907. One or more of the processor(s) 901 may be an Intel® Architecture microprocessor. For other embodiments, the processor(s) may be a different type of processor such as, for example, a graphics processor, a digital signal processor, an embedded processor, etc. and/or may implement a different architecture.

The one or more processors 901 may be operated with one or more clock sources 908 and provided with power from one or more voltage sources 910. The one or more processors 901 may also communicate with other levels of memory, such as memory 912. Higher memory hierarchy levels such as system memory (RAM) 918a and storage 918b, such as a mass storage device which may be included within the system or accessible by the system, may be accessed via host bus 914 and a chip set 916.

In addition, other functional units such as a graphics interface 920 and a network interface 922, to name just a few, may communicate with the one or more processors 901 via appropriate busses or ports. For example, the memory 912, the RAM 918a, and/or the storage 918b may include sub-sections that provide for dynamic sizing of the memory according to embodiments of the invention. Furthermore, one of ordinary skill would recognize that some or all of the components shown may be implemented using a different partitioning and/or integration approach, in variation to what is shown in FIG. 9, without departing from the spirit or scope of the embodiment as described.

For one embodiment, the storage 918b may store software such as, for example an operating system 924. For one embodiment, the operating system is a Windows® operating system, available from Microsoft Corporation of Redmond, Washington, that includes features and functionality according to the Advanced Configuration and Power Interface (ACPI) Standard (for example, ACPI Specification, Rev. 3.0, Sep. 2, 2004; Rev. 2.0c, Aug. 25, 2003; Rev. 2.0, Jul. 27, 2000, etc.) and/or that provides for Operating System-directed Power Management (OSPM). For other embodiments, the operating system may be a different type of operating system such as, for example, a Linux operating system.

While the system 900 is a mobile personal computing system, other types. of systems such as, for example, other types of computers (e.g., handhelds, servers, tablets, web appliances, routers, etc.), wireless communications devices (e.g., cellular phones, cordless phones, pagers, personal digital assistants, etc.), computer-related peripherals (e.g., printers, scanners, monitors, etc.), entertainment devices (e.g., televisions, radios, stereos, tape and compact disc players, video cassette recorders, camcorders, digital cameras, MP3 (Motion Picture Experts Group, Audio Layer 3) players, video games, watches, etc.), and the like are also within the scope of various embodiments. The memory circuits represented by the various foregoing figures may also be of any type and may be implemented in any of the above-described systems.

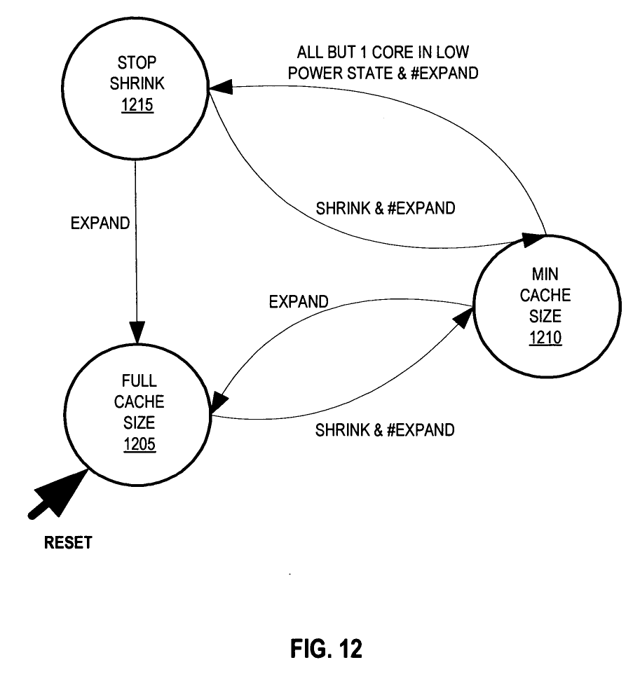

The memory power management module 907 of one embodiment may be implemented as a finite state machine (FSM). A state diagram corresponding to the operation of the memory power management module 907 of one example embodiment is shown in FIG. 12.

The memory power management module 907 may operate in cooperation with other features and functions of the processor(s) 901 such as the power management module 906. In particular, the power management module of one embodiment may control power management of the processor(s) 901 and/or of the individual core(s) 902 and 904, including transitions between various power states. Where the operating system 924 supports ACPI, for example, the power management module 907 may control and track the c-states of the various core(s) and/or the p-states. The power management module may also store or otherwise have access to other information to be used in managing the dynamic memory sizing approach of one or more embodiments such as, for example, the operating voltage/frequency of the processor and/or one or more cores, a minimum cache memory size, timer information, and/or other information stored in registers or other data stores.

With continuing reference to FIGS. 9 and 12, the memory power management module transitions between three high-level states (intermediate states may be included for various embodiments): Full Cache size 1205, Minimum Cache Size 1210, and Stop Shrink 1215. The transitions between these states may be managed in cooperation with a microcode (pcode) or other module 926 coupled to the memory 905. For the Full Cache Size state 1205, the microcode 926 is requested to return the cache back to its full size. This is the default (reset) state. For the Minimum Cache Size state 1210, the microcode 926 is requested to shrink the cache memory down to its minimum size. For some embodiments, the minimum size is programmable (e.g. via microcode) and may be determined by various design considerations such as, but not limited to, typical software profiles, acceptable delays in reducing cache size, a minimum size below which the memory is inoperable and/or other factors. It is noted that any minimum size for the memory may be dependent upon the state of the system, and therefore may not be constant over time, as one of ordinary skill in the art would appreciate. For the Stop Shrink state 1215, the microcode is requested to stop the cache shrink sequence. The ways or other sub-sections that have been disabled or shut down remain disabled, but the effective cache size is not reduced any further.

Transitions between these states may be managed according to certain variables which may be stored, for example, in a register or other data store (not shown). For one embodiment, for example, these variables may include, but are not limited to 1) all but one core in low power state, 2) ratio<=shrink threshold, 3) a c-state timer output, 4) at least one core in low power state, 5) ratio>shrink threshold, 6) expand and/or 7) shrink.

For the processor 901 of FIG. 9 including 2 cores and operating according to the ACPI specification, the variable “all but one core in low power state” may be set for one embodiment in response to determining that one core is already in a C4 state while the other, which may continue to execute during the dynamic memory sizing operations, is still in an active state (C0). For one embodiment, this variable should not be set if any of the cores have a break event pending. If two (or more) cores are present on the processor 901, but one (or more) of the cores is disabled or removed, then that core may be disregarded during the decision-making process.

The “ratio<=shrink threshold” variable may be set in response to the processor 901 or one of its cores, for one embodiment, being programmed to operate at a lower/equal frequency than a predetermined frequency set as the shrink threshold. The shrink threshold may be programmed for some embodiments and may be equal to zero.

One or more timer outputs may also be considered in determining whether to transition between states. For one embodiment, for example, a timer, such as an 8-bit down counter, for example, may be used to count the contiguous time that the processor (or a core) spends in the active or C0 state and may indicate when that time exceeds a pre-programmed threshold. For this example, a variable “C0 timer over threshold” may be used.

The variable “at least one core in a low power state,” for the example processor and system shown in FIG. 9, may be set when one of the cores has entered a stable C1, C2 or C3 state and not the C4 or WFS state.

The “ratio>shrink threshold” variable may be set when the processor or one of its cores is programmed to operate at a higher frequency than the shrink threshold. For some embodiments, if the shrink threshold equals 0, this ratio need not be taken into account when determining whether to expand the memory.

The “expand” variable may be set or dynamic memory expansion may be otherwise enabled for one embodiment if the ratio>shrink threshold, at least one core in low power state and/or the C0 timer>threshold. For other embodiments and/or implementations, the expand variable may be set under different conditions or in response to different inputs.

The “shrink” variable may be set or dynamic memory size reduction may be otherwise enabled for one embodiment if the ratio<=shrink threshold is set and all but 1 core in low power state is set.

With continuing reference to FIGS. 9 and 12, a transition from the Full Cache Size state 1205 to the Minimum Cache Size state 1210 may be undertaken for one embodiment for a multi-core processor in response to determining that one core is already in the C4 (or other low power) state, and when the processor 901 is operating below the shrink threshold p-state. It may be assumed then that the effective cache reduction will not substantially affect performance and therefore can be initiated. Concurrently, it may be confirmed that an effective memory expansion is not needed, e.g. that the C0 timer has not timed out indicating a possible rise in the activity factor.

Once microcode has entered the C4 flow on the core that is in the C4 state, the microcode may detect the request to reduce the effective size of the memory to the Minimum Cache Size and begin disabling ways or other sub-sections of the memory. For one embodiment, in the minimum cache size state 1210, ways or other sub-sections may be disabled one at a time. Other approaches may be used for other embodiments.

During the dynamic memory size reduction process, microcode may stop the shrink process after programmable chunks or other intervals to determine whether the shrink variable is still asserted. If it is not, the shrink process will be frozen. Further, if a pending interrupt occurs, the shrink process will be interrupted.

Once the pre-defined number of ways or other sub-sections has been shut down, the remaining core(s) may indicate a C4 state causing the entire processor 901 to enter into a C4 state. For some embodiments, this sequence may be repeated for every C4 entry of the last core until the cache memory has reached the pre-defined minimum size. From that point, a shrink request may be disregarded.

While in the Minimum Cache Size state 1210, if one core has exited the C4state and the conditions for an expand operation (or setting of an expand variable) have not been met or a pending break request exists for any core, the shrink variable may be negated and shrink process may be halted (i.e, the Stop Shrink State 1215 may be entered). This may be leave the memory 905 in an intermediate effective size until either the conditions to continue the shrink occur or conditions for an expand operation occur. If the effective memory 905 size is below a given number of ways or other sub-sections, such as a minimum number of ways below which the memory 905 will not operate properly and has either not reached “0” or a minimum size has been programmed at a given level, e.g. “re-open to 2”, the microcode may need to re-open the memory so that at least a given number of ways or other sub-sections are operational.

From either the Minimum Cache Size state 1210 or the Stop Shrink State 1215, an indication to effectively expand the memory 905 may occur. Expanding the memory 905 may be based on one or more indicators that an activity factor has increased. For one embodiment, indicators may include a transition to a higher p-state than the shrink threshold, one of the core(s) transitioning to a different power state, e.g. C1/2/3 instead of aiming for C4 and/or the C0 timer exceeding its threshold. Such occurrences may indicate that a program is in one of its longer activity stretches. If any of the above occur, the expand variable may be asserted or effective expansion of the memory 905 may be otherwise initiated.

For one embodiment, effective memory expansion may occur substantially instantaneously, i.e. not over multiple cycles apart from some delay to prevent current spikes. After expansion, the microcode will disregard an expand request. In addition to the above, upon every core C4 exit for some embodiments, microcode may check the shrink variable (or shrink control field), microcode may expand the memory back to a minimum number of ways before proceeding with a break to a higher power state.

For the shrink process, some additional considerations may apply to one or more embodiments. For example, for some embodiments, microcode may need to control the memory shrink segment entry with a semaphore so that only a single core may access the memory interface at one time. (It is assumed that the other core is in a core C4 state for the example embodiment described above, but this may not be guaranteed during an expand segment or process. In any case, event timing may cause a break before an atomic segment of the shrink flow is completed. The semaphore may ensure that the second core will not access the memory interface until the shrink/expand process is completed).

Further, to prevent memory 905 issues microcode may need to ensure that a second (or other) core is blocked into core C4 state when the shrink/reduction process occurs. For some embodiments, the may happen in hardware based on the same semaphore but microcode may need to account for the delay factor by rechecking the shrink indication before starting the actual atomic shrink flow.

Due to the potentially long shrink flow, microcode may need to periodically detect and ensure that there are no breaks pending and that a request to halt the shrink flow has not occurred. This may be done periodically after every “chunk” by testing if the shrink variable is still asserted. If microcode detects that the shrink conditions have ended, it should release the semaphore to ensure other core(s) can respond to break events and proceed with other flows. The shrink request/variable may be negated if any pending break events are detected and therefore, no interrupt window may need to be opened in the middle of the flow.

For some embodiments, as mentioned above, there may be a minimum effective size below which the memory 905 may not operate. For example, if the minimum size for the memory 905 is 2 ways (i.e. it may not function properly with only 1 way enabled), the shrink process may proceed directly from 2 ways to 0 ways enabled even if it is programmed to shrink 1 way or other sub-section at a time.

For a “normal” expand flow for one embodiment, microcode may try to capture the semaphore on every core C4 exit (unwind) regardless of whether an expand is required. Thus, the sleeping or low power core (for a multi-core processor) may not be able to begin execution during a shrink flow preventing possible contention with the shrink process. Memory expansion may be performed during an interrupt microcode handling routine. For some embodiments, as mentioned above, where the memory is inoperable below a minimum operable size, it may be expanded directly to the minimum operable size under certain conditions. For example, in an embodiment of the invention, in the case where a processor may implement an MWAIT state, an auto-expansion may be implemented on every MWAIT exit and the memory may proceed directly to the minimum operable effective size.

Machine Check Architecture (MCA) exceptions may occur either on a core exiting the shrink flow (e.g. a parity error on the memory 905) or on the other core(s), if its clock(s) have restarted and/or it has initiated a core C4 exit. In both cases, the memory 905 may have been reduced below the minimum operable size and may not have reached zero effective size. Since this is not a legal operational size and since it may be assumed that C4 may not be entered again soon, microcode may be required to fully expand the memory 905 in the MCA exception handler. Therefore, microcode may need to execute an unwind flow similar to that of MWAIT upon an MCA exception including capturing the semaphore, expanding the memory 905 to its maximum effective size (if it is not there already), releasing the semaphore and then moving the core to an active state.

In response to receiving a command to shrink the cache memory, one or more of the following set of operations may be performed:

1. Bias the allocation of new lines so that the ways to be disabled may not be allocated for new requests.

2. Scan all the locations in the ways to be disabled. In the event that valid data is found, it should be invalidated if it is clean data and should be written back if it was modified. It is noted that alternative coherency or write-invalidate protocols other than MESI (4-states: modified, exclusive, shared, invalid) may be implemented and used by the invention, as one of ordinary skill would recognize. For example, one or ordinary skill would find it readily apparent that either MOESI (5-states: modified, owner, exclusive, shared, invalid) or DRAGON (4-states: valid-exclusive, shared-clean, shared-modified, dirty) may be implemented.

3. Mark the ways to be disabled as ‘disabled’ and signal the state change to the memory.

During these operations, according to embodiments of the invention, all valid data in the ways to be disabled is available for both read and write accesses. In embodiments when the cache should be expanded, the memory power management logic may mark the ways which are to be enabled. According to embodiments of the invention, if any of the ways currently in a disabled state receive power such that their state may not be certain, then those ways may be invalidated before they are made available to the system or processor.

While many specifics of one or more embodiments have been described above, it will be appreciated that other approaches for dynamically reducing memory size may be implemented for other embodiments. For example, while specific power states are mentioned above, for other embodiments, other power states and/or other factors may be considered in determining that an effective memory size is to be expanded or decreased. Further, while a cache memory in a dual core processor in a personal computer is described above for purposes of example, it will be appreciated that a dynamic memory sizing approach according to one or more embodiments may be applied to a different type of memory and/or host integrated circuit chip and/or system.

For example, according to various embodiments of the invention, the memory power management logic or other software or hardware may monitor the work load of a host processor in general and/or of the memory in particular. The memory power management logic may issue a command to effectively shrink the memory depending upon a power state of all or part of the processor or computing system, if the processor is not active for a long period of time, and/or if an application consumes only a small part of the total available cache memory, for example. This may be done by disabling part of active memory, e.g. one or more ways, as in the example embodiment of FIG. 1. When the memory power management logic detects that the processor is active for a long time, all or a portion of the processor or host computing system is in a given power state and/or the cache size may not be large enough for the operations required of the processor or computer system, it may issue a command or otherwise control logic to expand the cache by enabling more of the memory.

Therefore, according to one embodiment of the invention, the hardware coordination monitor may iteratively determine when the required number of ways is less than an enabled number of ways and to deactivate the sleep device to disable one or more ways such that the enabled number of ways is substantially equivalent to the required number of ways.

Furthermore, using one or more coherency protocols, according to one embodiment of the invention, the hardware coordination monitor may scan the one or more ways for data to be at least written to a memory.

In another embodiment of the invention, the hardware coordination monitor may also iteratively determine when the required number of ways is more than an enabled number of ways and to activate the sleep device to enable one or more ways such that the enabled number of ways is substantially equivalent to the required number of ways.

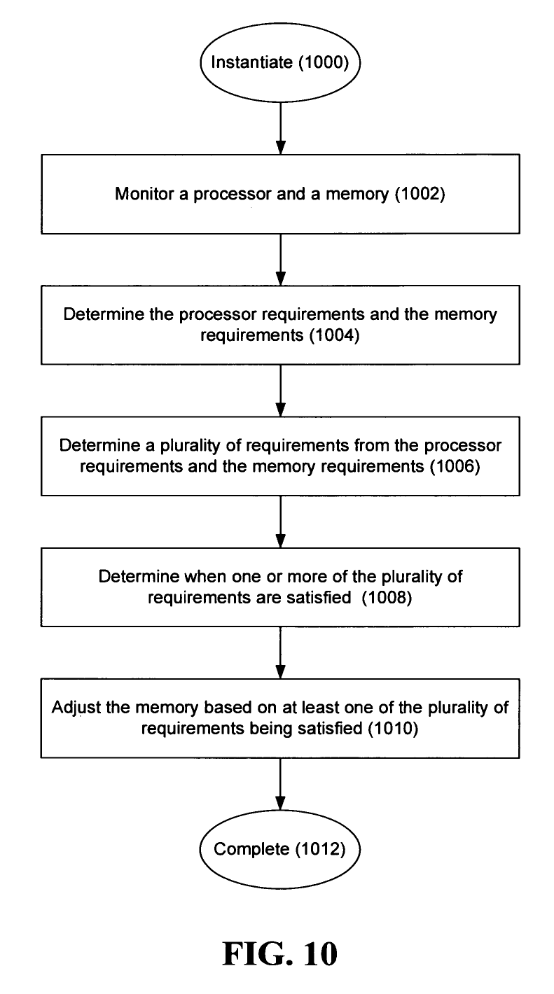

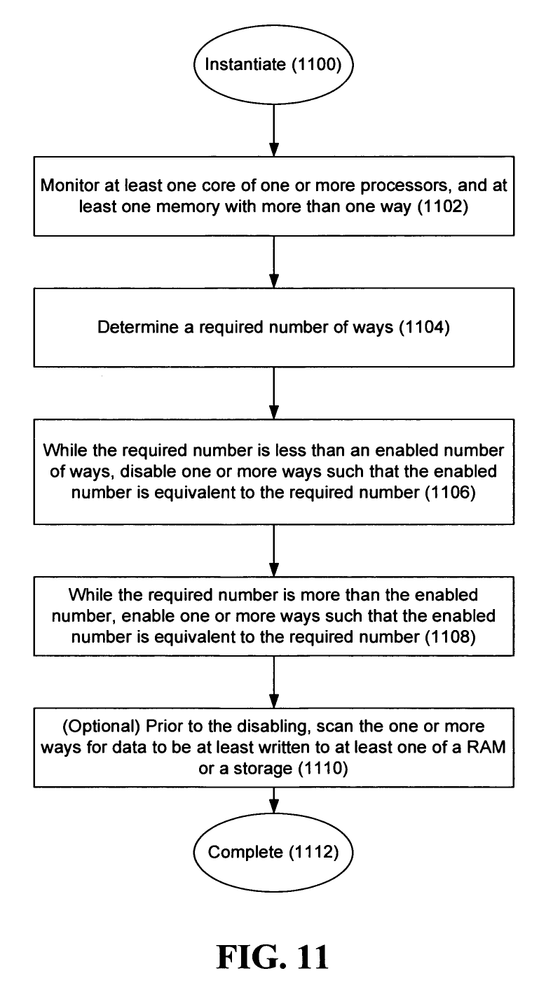

Embodiments of the present invention may include methods of performing the functions discussed in the foregoing description. For example, an embodiment of the invention may include a method for monitoring a processor and a memory, and adjusting the memory. The method may include additional operations, embodiments of which are described below with respect to FIGS. 10 and 11.

FIG. 10 shows a flowchart of the operations of one embodiment of the invention. The operations may instantiate at block 1000 and may proceed immediately to block 1002. At block 1002, the operation to monitor a processor and a memory may begin. According to embodiments of the invention, there may be more than one processor and each processor may have one or more cores, any of which may also be monitored. The process then proceeds to block 1004.

At block 1004, the process to determine the processor's requirements and the memory's requirements may begin. According to embodiments of the invention, the various management standards, such as but not limited to OSPM and ACPI, may provide thresholds or requirements, such as but not limited to various c-states or p-states or combinations of the two, as well as various cache-hit or cache-miss levels, through which the hardware coordination monitor may determine the memory needs of the system. The process then proceeds to block 1006.

At block 1006, the process to determine a plurality of requirements from the processor's requirements and the memory's requirements may begin. According to embodiments of the invention, the plurality of requirements may be a prioritized or other ordered list which may provide the system, enabled with one or more embodiments of the invention, to perform the enabling or disabling of the memory. The process then proceeds to block 1008.

At block 1008, the process to determine when one or more of the plurality requirements are satisfied may begin. According to embodiments of the invention, the memory power management logic may provide this determination. As described elsewhere herein, the memory power management logic, such as, but not limited to memory power management logic 906, may have access to the plurality of requirements determined at block 1006. The process then proceeds to block 1010.

At block 1010, the operation to adjust the memory based on at least one of the plurality of requirements being satisfied may begin. As described elsewhere herein, the embodiments of the invention provide for the enabling of memory based on at least the need for that memory to be available to the system. In other embodiments of the invention, the memory may have ways which are not needed and may therefore be disabled. The process is then complete and proceeds to block 1012. At block 1012, the operation may begin again at block 1000. In alternative embodiments of the invention, the operation may begin at any of the blocks of FIG. 10, as one of ordinary skill in the art would recognize based at least on the teachings provided herein.

FIG. 11 shows a flowchart of the operations of another embodiment of the invention. The operations may instantiate at block 1100 and may proceed immediately to block 1102. At block 1102, the operation to monitor at least one core of one or more processors, and at least one memory with more than one way may begin. The process then proceeds to block 1104.

At block 1104, the process to determine the required number of ways may begin. According to embodiments of the invention, the various management standards, such as but not limited to OSPM and ACPI, may provide thresholds or requirements, such as but not limited to various c-states or p-states or combinations of the two, as well as various cache-hit or cache-miss levels, through which the hardware coordination monitor may determine the memory needs of the system. The process then proceeds to block 1106.

At block 1106, while the required number of ways is less than an enabled number of ways, the process may begin to disable one or more ways such that the enabled number of ways is substantially equivalent to the required number of ways. According to embodiments of the invention, the process may disable unneeded ways in more than one step, or in an iterative manner, or all at once, being enabled with one or more embodiments of the sleep device, to perform the disabling of the memory. The process then proceeds to block 1108.

At block 1108, while the required number of ways is more than the enabled number of ways, the process may begin to enable one or more ways such that the enabled number of ways is substantially equivalent to the required number of ways. According to embodiments of the invention, the memory power management logic may provide the determinations of at least one of blocks 1106 and 1108. As described elsewhere herein, the memory power management logic, such as, but not limited to memory power management logic 906, may have access to the plurality of requirements determined at block 1006. The process then proceeds to block 1110.

At block 1110, the optional operation to scan the one or more ways, prior to their being disabled in block 1006, for data to be at least written to memory may begin. In other embodiments of the invention, the memory may have ways which are not needed and may therefore be disabled. The process is then complete and proceeds to block 1112. At block 1112, the operation may begin again at block 1100. In alternative embodiments of the invention, the operation may begin at any of the blocks of FIG. 11, as one of ordinary skill in the art would recognize based at least on the teachings provided herein.

In light of the some of the above processes and their operations, embodiments of the invention, whether an apparatus or memory device may operate by monitoring at least one core of one or more processors; monitoring a memory including more than one way; determining a required number of ways; and while the required number of ways is less than an enabled number of ways, the apparatus or memory device may iteratively enabling one or more ways such that the enabled number of ways is substantially equivalent to the required number of ways.

Furthermore, prior to the disabling of the one or more ways, the apparatus or memory device may scan the one or more ways for data to be at least written to a memory.

In addition, according to another embodiment of the invention, while the required number of ways is more than an enabled number of ways, the apparatus or memory device may iteratively disabling one or more ways such that the enabled number of ways is substantially equivalent to the required number of ways.

Any reference in this specification to “one embodiment,” “an embodiment,” “example embodiment,” etc., means that a particular feature, structure, or characteristic described in connection with the embodiment is included in at least one embodiment of the invention. The appearances of such phrases in various places in the specification are not necessarily all referring to the same embodiment. Further, when a particular feature, structure, or characteristic is described in connection with any embodiment, it is submitted that it is within the purview of one skilled in the art to affect such feature, structure, or characteristic in connection with other ones of the embodiments. Furthermore, for ease of understanding, certain method procedures may have been delineated as separate procedures; however, these separately delineated procedures should not be construed as necessarily order dependent in their performance. That is, some procedures may be able to be performed in an alternative ordering or simultaneously, as one or ordinary skill would appreciate based at least on the teachings provided herein.

Embodiments of the present invention may be described in sufficient detail to enable those skilled in the art to practice the invention. Other embodiments may be utilized, and structural, logical, and intellectual changes may be made without departing from the scope of the present invention. Moreover, it is to be understood that various embodiments of the invention, although different, are not necessarily mutually exclusive. For example, a particular feature, structure, or characteristic described in one embodiment may be included within other embodiments. Accordingly, the detailed description is not to be taken in a limiting sense.

The foregoing embodiments and advantages are merely exemplary and are not to be construed as limiting the present invention. For instance, the present teaching can be readily applied to other types of memories. Those skilled in the art can appreciate from the foregoing description that the techniques of the embodiments of the invention can be implemented in a variety of forms. Therefore, while the embodiments of this invention have been described in connection with particular examples thereof, the true scope of the embodiments of the invention should not be so limited since other modifications will become apparent to the skilled practitioner upon a study of the drawings, specification, and following claims.

What is claimed is:

1. An apparatus comprising:
a memory including a plurality of ways, wherein each way includes at least one memory cell;
a sleep device coupled to one or more ways of the plurality of ways, the sleep device to disable the one or more ways; and
a memory power management logic coupled to the sleep device, the memory power management logic to control the sleep device based on one or more requirements.

2. The apparatus of claim 1, the memory power management logic to monitor the operation of at least one selected from the group consisting of i) one or more processors, ii) one or more cores in each of the one or more processors, iii) one or more parameters of the operating system, and iv) one or more parameters of the memory.

3. The apparatus of claim 1, wherein one of the one or more requirements is based on a required number of ways of the plurality of ways.

4. The apparatus of claim 3, the hardware coordination monitor to iteratively determine when the required number of ways is less than an enabled number of ways and to deactivate the sleep device to disable one or more ways such that the enabled number of ways is substantially equivalent to the required number of ways.

5. The apparatus of claim 4, the hardware coordination monitor to scan the one or more ways for data to be at least written to a memory.

6. The apparatus of claim 3, the hardware coordination monitor to iteratively determine when the required number of ways is more than an enabled number of ways and to activate the sleep device to enable one or more ways such that the enabled number of ways is substantially equivalent to the required number of ways.

7. The apparatus of claim 1, wherein the sleep device includes more than one sleep transistor.

8. The apparatus of claim 1, wherein the sleep device includes logic to at least monitor the state of one or more ways of the plurality of ways.

9. The apparatus of claim 1, wherein the memory includes a static random access memory (SRAM) array.

10. A memory device comprising:
a memory including a plurality of ways, wherein each way includes at least one memory cell;
a sleep device coupled to one or more ways of the plurality of ways, the sleep device to disable the one or more ways; and
a memory power management logic coupled to the sleep device, the memory power management logic to control the sleep device based on one or more requirements.

11. The memory device of claim 10, the memory power management logic to monitor the operation of at least one selected from the group consisting of i) one or more processors, ii) at least one core in each of the one or more processors, iii) one or more parameters of the operating system, and iv) one or more parameters of the memory.

12. The memory device of claim 10, wherein one of the one or more requirements is based on a required number of ways of the plurality of ways.

13. The memory device of claim 12, the hardware coordination monitor to iteratively determine when the required number of ways is less than an enabled number of ways and to deactivate the sleep device to disable one or more ways such that the enabled number of ways is substantially equivalent to the required number of ways.

14. The memory device of claim 13, the hardware coordination monitor to scan the one or more ways for data to be at least written to a memory.

15. The memory device of claim 12, the hardware coordination monitor to iteratively determine when the required number of ways is more than an enabled number of ways and to activate the sleep device to enable one or more ways such that the enabled number of ways is substantially equivalent to the required number of ways.

16. The memory device of claim 10, wherein the sleep device includes more than one sleep transistor.

17. The memory device of claim 10, wherein the sleep device includes logic to at least monitor the state of one or more ways of the plurality of ways.

18. The memory device of claim 10, wherein the memory includes a static random access memory (SRAM) array.

19. A method comprising:
monitoring at least one core of one or more processors;
monitoring a memory including more than one way;
determining a required number of ways; and
while the required number of ways is less than an enabled number of ways iteratively enabling one or more ways such that the enabled number of ways is substantially equivalent to the required number of ways.

20. The method of claim 19, further comprising:
prior to the disabling of the one or more ways, scanning the one or more ways for data to be at least written to a memory.

21. The method of claim 19, further comprising:
while the required number of ways is more than an enabled number of ways iteratively disabling one or more ways such that the enabled number of ways is substantially equivalent to the required number of ways.

22. An apparatus comprising:
a memory implemented on a single integrated circuit chip, the memory including a plurality of sub-sections, wherein each sub-section includes at least one memory cell; and
memory power management logic coupled to the memory, the memory power management logic responsive to at least a power state to selectively and individually control enabling and disabling of at least some of the sub-sections.

23. The apparatus of claim 22, wherein the memory comprises a cache memory and the sub-sections comprise ways.

24. The apparatus of claim 22, further comprising:
a plurality of sleep devices, at least one sleep device being coupled to each of the plurality of sub-sections, each of the sleep devices being responsive to the memory power management logic to control enabling and disabling of the respective sub-section.

25. The apparatus of claim 24, wherein each of the sleep devices comprises at least a first transistor coupled between a power supply and the respective sub-section.

26. The apparatus of claim 22, wherein the power state comprises a power state of at least a first microprocessor core.

27. The apparatus of claim 22, wherein the memory power management logic, in response to receiving a request to reduce the effective size of the memory, is to disable one sub-section at a time until a minimum effective memory size is reached or until a stop shrink condition is detected.
